(19) United States
(12) Patent Application Publication
(10) Pub. No.: US 2011/0031932 A1
(43) Pub. Date: Feb. 10, 2011

(54) METHOD FOR RECOVERING AN ACCUMULATOR BATTERY AND APPARATUS FOR PERFORMING THEREOF

(76) Inventor: Gennadiy Dmitrievich Platonov, Moscow (RU)

Correspondence Address: Law Office of Anna Vishev P.C, 44 Cortelyou Avenue, Staten Island, NY, 10312, US

(21) Appl. No.: 12/757,990

(22) Filed: Apr. 10, 2010

(30) Foreign Application Priority Data
Aug. 7, 2009 (RU) 2009130283

(51) Int. Cl. H02J 7/00; H02J 7/04

(52) U.S. Cl. 320/134; 320/152

(57) ABSTRACT

A method for recovering the accumulator battery, according to which method performed are the steps of: charging the accumulator battery that is carried out by passing therethrough the sequence of the rectangular current pulses which have a magnitude in the range of 400 to 480 A and a duty factor of 100 to 400; discharging the accumulator battery that is carried out in the pauses between the actions of the rectangular pulses for charging; and ceasing the cycles of charging with the rectangular pulses and discharging in the pauses therebetween when the measured amounts reach the values of the parameters defining the end of the process for charging the battery and recorded preliminary into the memory; then measuring the battery capacity by using the control discharge of the battery, and ceasing the control discharge when the voltage amount of the battery reaches the maximum permissible value set for this battery.

### CROSS-REFERENCE TO RELATED APPLICATIONS

This application claims all rights of priority to Russian Patent Application No. 2009130283, filed Aug. 7, 2009 (pending), the disclosure of which is incorporated herein by reference.

### BACKGROUND OF THE INVENTION

The invention generally relates to the field of electrical technology. More particularly, the invention relates to an apparatus converting chemical energy into the electrical one, and to recovery of voltage power supplies, predominantly, the accumulator batteries.

At present, the problem of the energy supply security becomes increasingly actual for both developed and developing economics of the world community. The ever-growing urgency of the problem is conditioned by several fundamental factors accompanying the world evolution. First of all, it is the limit of non-renewable hydrocarbon reserves, i.e., oil, coil, and gas. Replacement of raw material sources used conventionally for power generation by renewable sources such as wind, solar energy, tidal energy, etc., is restricted significantly by specific climatic and geographic characteristics of each economic or specific world region, besides multibillion investments required for carrying out the needed investigations, pilot projects, and bringing them to the industrial use. A wide tendency that took place in the 20th century for building heat-electrical power stations, which solved partially the problem for reducing the consumption of liquid hydrocarbons, had mainly come to the end of possibilities thereof at the end of the 20th, beginning of the 21st century. This is particularly due to the fact that the world science community believes that the predicted global warming is mainly associated with origination of the greenhouse effect based on the fact of increasing in the Earth's atmosphere of the carbon dioxide, which in significant part consists of discharges of said heat-electrical power stations. The Kyoto protocol adopted by some countries of the world community has also some impact on the development of the heat-power engineering.

Besides the growth of the industrial consumption of electric energy, the continuing automobilization process, electronization of manufacture, and, especially, people's life, there is an exponential increase of demand on self-contained power supplies, both traditional accumulator batteries widely used in various industry and economic branches, and miniature high-efficient rechargeable batteries employed as the power supplies for portable personal computers, electronic translators, video-cameras, mobile phones, etc. Among these, are various accumulators including rechargeable batteries, for example, lead-acid batteries, nickel-cadmium batteries, nickel-metal-hydride batteries, nickel-zinc batteries, rechargeable lithium batteries, etc.

Such an explosive effect of the increasing demand on self-contained power sources causes simultaneously a problem of their utilization upon completing their operational life. It is known that, in practice, all self-contained comprise materials may pollute seriously the environment in the case of destructing the element construction. This is also one of the main reasons that actively stimulate searches for ways of increasing the number of cycles for using the self-contained power sources.

The background analysis shows that there are at least two directions in solving the problem related to the increase of the number of cycles for using the self-contained power sources and, hence, the problem of their utilization. For our purposes, they could be referred to as mechanical and electrical.

In self-contained power sources, such as accumulators and galvanic cells, current is generated as a result of chemical processes, i.e., the reactions occurring in those sources. In galvanic cells, the chemical compounds obtained as a result of said reactions cannot be degraded again and returned into the initial condition under the influence of the direct current, because during those processes, the material of electrodes and the solution where they reside are spent. In other words, the chemical processes in such elements are irreversible. There is a great number of known various self-contained power sources whose operation is based on the principle of reversibility of the chemical processes. Accumulators are the most known of such power sources. Lead dioxide PbO₂ and mossy lead Pb used for manufacturing construction elements of accumulators are characterized by high chemical stability in the electrolyte of sulfuric acid H₂SO₄. In the lead-acid accumulator, the active material utilization factor is around 0.4, i.e., during the accumulator operation, around 40% of the active material enters into the chemical reaction with the electrolyte, around 60% thereof does not interact during the entire accumulator operation process, and the chemical composition thereof remains constant. The reacted active material (40%) precipitates, and this mud could be recovered.

From the background, a great number of technical solutions is known concerning the mechanical direction in recovering the accumulator sources. Known are methods and apparatus for recovering the components of the enclosed-type batteries including the steps of reducing the ion conductance between cathode and anode, opening the battery case, and recovering the battery components, wherein the step of reducing the ion conductance is carried out by removing the electrolyte solution using the safety ventilation channels, and followed by the step of cooling the battery below the chilling point of the electrolyte solution or below the glass-transition temperature of the cured polymer of the polymer electrolyte (see SU 1034559 A, 26.04.1995; SU 877660 A, 30.01.1981; RU 94025555 Al, 20.05.1996; DE 4424825 Al, 18.01.1986; RU 2201018 C2, 05.03.1997; [symbol] [symbol] [symbol] [symbol] [symbol] [symbol] [symbol] [symbol] [symbol] 1991, c. 94 (Severny A. E. et al., Employing, storing, and repairing the accumulator batteries [in Russian]); USSR inventor's certificate No. 112833).

Further, in the known method for recovering the lead-acid accumulator batteries, these batteries are divided into positive and negative semi-units, where the positive and negative plates are collected, the invalid plates are replaced by new ones, whereupon the accumulator battery is assembled and charged ( [symbol] [symbol] [symbol] [symbol] [symbol] [symbol] [symbol] [symbol] [symbol] 1991. c. 94 (Severny A. E. et al. Employing, storing, and repairing the accumulator batteries [in Russian])). In order to recover these batteries, it is necessary to get new plates, which is rather expensive, and moreover, this method does not provide for utilizing the worked-out precipitated lead, which finally results in soiling the environment.

As one more technical solution representing the “mechanical” recovering, the method for recovering the lead-acid accumulator batteries, wherein the worked-out accumulator battery is also divided into the semi-units of the positive and negative plates, the destroyed positive plates are reduced to powder, the obtained powder is mixed with the electrolyte till forming a dough which is deposited onto meshes, then pressed and dried, the accumulator battery is recovered and assembled, whereupon the accumulator battery is charged (USSR inventor's certificate No. 112833, Int. Cl. H01M 10/54, 1958).

In a working accumulator battery, sulfation of the plates occurs, which is accompanied by precipitating a portion of the mass of the positive and negative plates. However, the final electrochemical destruction of all components does not happen. In connection with this, utilization of the mass of the positive plates in pure form, as this is alleged in said inventor's certificate, seems to be very difficult, and practically impossible. Moreover, in order for transforming the obtained dough into an active mass, the dough needs to be subjected to the forming process, only which results in originating a mass being chemically active.

The indicated disadvantages are eliminated in the method for recovering the lead-acid accumulator batteries, which includes the steps of dividing the worked-out battery into the positive and negative semi-units represented by positive and negative plates, reducing the positive plates to powder, mixing the obtained powder with the electrolyte till forming a dough which is deposited onto meshes, then pressed and dried; whereupon the accumulator battery is recovered, assembled, and charged, wherein, simultaneously with the step of reducing in size the mass formed from destructing the positive plates, is performed the step of reducing the precipitation residing in the worked-out accumulator battery till obtaining particles having a size of 0.02 to 0.04 μm. The step of mixing the produced powder with the electrolyte is performed while maintaining the ratio 1:0.13 weight parts. The method also includes the steps of removing from the grids of the negative plates the mossy lead having the sulfation degree of more than 20%, pressing the obtained dough deposited onto the meshes at the pressure of 20 to 30 atmospheres and drying thereof at the temperature of 30 to 100° C. for 24 hours, forming the produced positive plates into the semi-units, whereupon, forming the negative semi-units from the negative plates whose sulfation degree is less than 20%, assembling from the formed positive and negative semi-units the units of the accumulator battery, placing these units, prior to charging thereof, into the case with the distilled water and passing the direct current having the current strength of 0.03 to 0.05 A until lead dioxide is formed on the positive plates and mossy lead in the active form is formed on the negative plates, whereupon charging the Accumulator battery (RU 2076403 C, Int. Cl. H01M 10/54, 1994).

The known method permits for eliminating the disadvantages inherent to the USSR author's certificate No. 112833. However, this is achieved by using complex technological processes, which could not be carried out in simple conditions of auto repair shops.

Form the viewpoint of the technological process and employed accessory for implementation of the proposed technologies, relatively simpler is the method for recovering lead accumulators including the steps of disassembling the units, recovering the negative electrodes having bulgy active mass without removing the mass from the grid, by means of pressing these electrodes with canvas inserts, washing the active mass of the positive electrodes along with the grid in distilled water, then drying, reducing in size, and subjecting to the thermal action at the temperature of 450 to 500° C. till acquiring a yellow color, mixing the obtained powder with distilled water, and, thereafter, adding the sulfuric acid solution having density of 1/40 g/cm³ till forming the dough, smearing the dough into the electrode once; compressing the electrode with the smeared dough twice by rolling between rubber roller and then, after pre-drying at 120° C. for 20-25 seconds or after exposing to air for 4-6 minutes, by rolling again between the rollers wrapped with mull; whereupon, curing the manufactured plates at the temperature of 45 to 50° C. and air humidity of not less than 95% for 16 to 18 hours, then at the same temperature along with the humidity reduced to 75% for another 20 hours; drying the plates at the temperature of 68 to 70° C. and air humidity of not more than 20% for 12-14 hours; charging the accumulator after assembling thereof, wherein, in the step of assembling the electrode semi-units, using once more the separators recovered after dissembling the worked-out accumulators by cleaning mechanically their surface from the products of electrochemical transport and boiling in distilled water for 5 minutes [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] Shevchenko N. P. Technique and means for recovering the worn-out lead-acid accumulator batteries: Thesis for Ph. D. in technique sciences. Ryazan [in Russian]) BA [symbol] , 2000, pp. 74-77, 89).

When analyzing the technical solutions concerning the “mechanical” recovery of accumulator batteries, one could affirm that at the basis of each of them is a technological process, which is not simple, but rather lengthy and labor-intensive, and requires, in some cases, complex technological equipment. These disadvantages were the incentive for seeking other solutions for recovering the accumulator batteries, which could be more efficient. As mentioned above, such a direction is formed and has been referred to as “electrical”.

There are many technical solutions concerning the “electrical” methods for recovering the accumulator batteries in the background: DD 38201 A; SU 909754 A, 1982; SU 911677 A, 1982; SU 1713015 A1, 1992; [symbol] [symbol] [symbol] [symbol] (Bolotskiy V.S. Chemical current sources [in Russian])—M.: [symbol] , 1981, c. 238-239; U.S. Pat. No. 4494062 A, 1985; U.S. Pat. No. 4,568,869 A, 1986; [symbol] [symbol] (Russian Industry [in Russian]), No 9, 1999, c. 18-20; SU 1702873 A3, 1991; RU 9408854 A1, 1996; SU 851569 A, 1981; U.S. Pat. No. 5,631,542 A, 1997; U.S. Pat. No. 5,614,805 A, 1997; RU 2153741 C2, 2000; RU 2025022 C1, 1994; DE 3811371 A1, 1990; RU 2226019 C1, 2004; RU 2218696 C1, 2003; SU 1534634 A1, 1990; WO 91/07000, 1991; U.S. Pat. No. 5,541,966 A, 1996; EP 0444617, 1991; EP 1184928 A1, 2002; WO OO/62397 A1, 2000; JP 2001-118611 A, 2001; JP 2006-032065 A, 2006; JP 2000-323188 A, 2000.

The analysis of the technical solutions related to the “electrical” direction of recovering accumulator batteries shows that, in comparison with the “mechanical” direction, it differs by an absence of complex, labor-intensive, and time lengthy technological processes. Apparatus used for implementing such methods for recovering contain common electronic devices and units widely employed in laboratory conditions.

Known is the method for recovering the voltage sources in the form of primary cells, which method includes the step of acting, during the predetermined time interval, on the voltage source being recovered by periodical voltage pulses having the preset amplitude and the preset length, said voltage pulses having a short rise time and being fed at a rate of 2 to 200 Hz with the length of 10⁻³ to 2 ×10⁻³s, and the recovery current being set within the range of 5 ×10⁻² to 15A and adjusted depending on the internal resistance of the voltage source being recovered. The apparatus for implementing this method includes the dc voltage source for feeding the dc signal to the switch clocked by the clock signal generator, and the timer for ensuring the process of the voltage source recovery during the predetermined time interval, wherein the switch output producing the sequence of the voltage pulses having a constant amplitude, short rising time and predefined constant length being connected to the pole of the voltage source for recovering thereof(RU 2153741 C, Int. Cl.⁷ H01M 10/44, H02J 7/10, 1994).

Also known is the method for recovering nickel-cadmium accumulators comprised into a battery, which method includes the step of preliminary discharging the accumulator battery from 0 to 0.5V followed by the step of charging thereof up to the maximal value provided by the technical characteristics, wherein, prior to the steps of discharging and charging the accumulator battery, steps of charging and measuring the battery voltage and comparing the charge with the preset value are performed, wherein, in the absence of shorted elements in the battery, at least one regeneration cycle is performed including the discharging and charging of the battery using the alternating current having a constant amplitude and a frequency of 20 KHz to 80 Hz of the saw-tooth configuration asymmetric relative to 0V, and having the ratio of the mean value of the charge current to the mean value of the discharge current as (20-4):1 in the charge mode and as 1:(4-20) in the discharge mode with amplitude of the pulse leading edge exceeding 4-5 times the mean value of the charge current; and in the case of the present of the shorted elements, prior to the recovery cycle, the step of charging the battery with the nominal current is preliminary performed, then the accumulator battery are connected several times to the capacitor having the capacity of 10,000 μF charged up to voltage of 25 to 60V followed by the step of charging the accumulator battery up to the nominal value with the leveling current which is 4-10 times less than the nominal one, whereupon the recovering cycle consisting of discharging the battery is repeated. Known also is the apparatus for implementing this method for recovering. which apparatus comprises: the power unit, the charging-discharging unit connected to the battery, the charging-discharging unit including the drive generator configured for charging and discharging the accumulator battery, as well as the control and indication unit, the drive generator being connected by control circuits to the control and indication unit, and the output of the drive generator being connected to input of the current generator, which output being connected to the accumulator battery connected also to the control and indication unit, wherein the added unit of capacitors is provided with the switch ensuring the release thereof from the voltage of 25 to 60V and connecting to the accumulator battery (RU 2185009 C, Int. Cl.⁷ H01M 10/54, 2000).

Said technical solutions related to the “electrical” direction of the accumulator battery recovery permitted to eliminate to a considerable extent the disadvantages inherent to the “mechanical” direction of the recovery, especially in the part of simplifying the recovery process. However, they still do not provide for conducting a really effective recovery of the power characteristics up to the level of characteristics present in unused sources. Therefore, the number of possible recovery cycles is limited.

Known is the method for charging the accumulator battery by the bipolar pulse current, in which method the source being recovered is affected by the sequence of unipolar current pulses with pauses, the discharging current pulse of a great amplitude is fed during one of these pauses, wherein said sequence is formed by means of the dc source having a limited capacity. The proposed form of the actuating pulses permits to reduce the heat liberation occurred in the source being recovered, and moreover, enhances the conditions for executing the recovery process itself, since during the action of the sequence of the alternating pulses with the pauses between them the growth of the static polarization of the accumulator battery is decelerated, because in the moment of acting with the discharge pulse of a great amplitude, the depolarization emerges lowing the accumulated battery polarization (SU 1534634 A1, Int. Cl.⁷ H02J 7/10). Nevertheless, regardless said technical result, in the batteries recovered by such a method, the working agent begins, with the course of time, to form large crystal bodies. At the beginning stage of the implementation a progressing loss of the battery power and an increase of the inner resistance of the battery occur, since the area of contact of the anode with the electrolyte decreases. At later stages, the growing crystals begin to exert the destructive effect onto the separator plate that divides the anode and cathode. In recovering, such accumulators show a high capacity value, but are not suitable for further exploitation due to the great current of self-discharge.

The indicated disadvantages have been successfully overcome in the method for charging and recovering the accumulator, which method includes the steps of: inputting the charge current to the accumulator being charged; inducing in the accumulator the mechanical vibration by means of forming the charging pulse in the form of the pulse series having a high frequency in the range of 3 to 30 KHz (RU 2226019 C. Int. Cl.⁷ H02J 7/00, 2002).

In fact, by the action of the discharge pulses, the large crystal structures at the surfaces of the accumulator elements are reduced in size, which decreases the inner resistance of the accumulator in charging. At the same time, this also results in accelerated creeping and sloughing of the active mass of the positive electrodes caused by the irreversible disintegration, failure of uniformity and mechanical strength of the active mass.

The closest to the claimed invention group according to the technical essence and achieved result in the part of method for recovering the accumulator battery is the method including the steps of: charging preliminary the accumulator battery with the direct current; then charging the accumulator battery by passing the sequence of rectangular current pulses; measuring, during the charging process, the voltage across the battery, the electrolyte temperature and density; and storing the measured parameters in the memory of the measuring means; wherein, in accordance with the invention, prior to the beginning of the process for recovering the accumulator battery, the parameters of the technological process for recovering the accumulator battery are recorded into the memory of the measuring means, and these parameters are compared during the process for recovering the accumulator battery with the actual amounts of the parameters of the process for recovering the accumulator battery, which recorded parameters are corrected in the case of departure thereof from the preset value of the parameters of the technological process; the step of charging the accumulator battery with the direct current is ceased when the actual amounts of the parameters reach the preset values of the parameters recorded in the memory of the measuring means, whereafter the accumulator battery is charged by passing through the sequence of the rectangular current pulses which length is set in the range of 150 to 600 ms and a pause between the pulses is from 2 to 6 seconds, herewith the amplitude of the rectangular pulses is held unchanged at the temperature of the electrolyte below the predetermined amount, and in the case when the value of the temperature of the electrolyte exceeds this predetermined amount, the amplitude of the rectangular current pulses is reduced to the value at which the temperature of the electrolyte is decreased to the predetermined amount; the charging process is ceased when the measured amounts reach the values of the parameters defining the end of the process for charging the battery and recorded preliminary into the memory of the measuring means; then measuring the battery capacity by means of discharging the battery, which is ceased when the voltage amount of the battery reaches the maximum permissible value set for this battery; and the cycle of recovering the accumulator battery is repeated when the battery capacity is less than 80% from the nominal amount (RU 2309509 C, Int. Cl.⁷ H02J 7/00, H01M 10/54, 2006).

In this technical solution, the above indicated disadvantages inherent to the known technical solutions have been eliminated, however, this known method is characterized by a rather long time period required for recovering the battery, the battery capacity could not be recovered to its nominal amount, and a great quantity of the electrical power is consumed.

The closest to the claimed invention group according to the technical essence and achieved result in the part of apparatus is the apparatus for recovering the accumulator battery, which apparatus comprises: the unit of the charge current sources which output serves for connecting to the accumulator battery; the current sensor; the voltage sensor; the temperature sensor; the electrolyte density meter; the memory unit; the processor, the interface unit; the indication unit; and the decoder: wherein the memory unit and the indication unit are connected to the processor, the current sensor, voltage sensor, temperature sensor and electrolyte density meter are connected to the processor through the interface unit, the processor output is connected to the input of the decoder which first output is connected to the input for controlling connection of the charging current sources and which second output is connected to the input for controlling the charging current parameters of the unit of the charge current sources (RU 2309509 C, Int. Cl.⁷ H02J 7/00, H01M 10/54, 2006). In this apparatus, the series of the disadvantages inherent to the apparatus representing the known background have been eliminated, and the recovery of the accumulator battery capacity has been increased up to 80% from the nominal level. But therewith, the time for recovering the accumulator battery capacity in accordance with this technical solution is rather long and ranges from 96 to 144 hours, and the recovered capacity is . within the range of 70 to 87%. Moreover, this method is characterized by great power consumption.

### SUMMARY OF THE INVENTION

The problem solved by the claimed invention group lies in developing the method for recovering the accumulator batteries and the apparatus for carrying out thereof, which are free from the above indicated disadvantages and ensure a significant increase in the dynamics of the process of destructing the crystalline formations, as well as an acceleration of recovering the chemical structure of the accumulator battery elements.

The technical result caused by employing the claimed invention group consists in ensuring a complete cleaning of the plates of the accumulator battery being recovered from lead sulfate, reducing the time of the process for recovering the capacity to the level of the nominal value of 97 to 99% to 45-30 hours, and reducing 3-5 times the electrical power consumption for the recovery process.

The object underlying the claimed invention group along with achieving said technical result in employing thereof, in the part of method for recovering the accumulator battery, is achieved by that in the known method for recovering the accumulator battery including steps of: charging preliminary the accumulator battery with the direct current; then charging the accumulator battery by passing therethrough the sequence of rectangular current pulses; measuring, during the charging process, the voltage across the battery, the electrolyte temperature and density; logging the measured parameters; recording, prior to the beginning of the process for recovering the accumulator battery, the parameters of the technological process for recovering the accumulator battery into the memory; comparing, during the process for recovering the accumulator battery, these recorded parameters with the actual amounts of the accumulator battery parameters, and correcting these recorded parameters in the case of departure thereof from the preset value of the parameters of the technological process; ceasing the step of charging the accumulator battery with the direct current when the actual amounts of the battery parameters reach the preset values of the recovery process parameters recorded in the memory, whereafter the accumulator battery is charged by passing through a sequence of the rectangular current pulses which amplitude is held unchanged at the temperature of the electrolyte below the predetermined amount, and in the case when the value of the temperature of the electrolyte exceeds this predetermined amount, then the amplitude of the rectangular current pulses is reduced to the value at which the temperature of the electrolyte is decreased to the predetermined amount; wherein, in accordance with the present invention, the step of charging the accumulator battery is carried out by passing through the sequence of the rectangular current pulses which have a magnitude in the range of 400 to 480 A and a duty factor of 100 to 400; the step of discharging the accumulator battery is carried out during pauses between the actions of the rectangular pulses for charging; and ceasing the cycles of charging with the rectangular pulses and discharging in the pauses therebetween when the measured amounts reach the values of the parameters defining the end of the process for charging the battery and recorded preliminary into the memory; then measuring the battery capacity by using the control discharge of the battery, and ceasing the control discharge when the voltage amount of the battery reaches the maximum permissible value set for this battery. The above proposed cycle is repeated when the battery capacity is less than 90% from the nominal amount. Further, the voltage monitoring is performed similarly to the temperature monitoring.

The object underlying the claimed invention group along with achieving said technical result in employing thereof, in terms of the apparatus for performing the method for recovering the accumulator battery, is achieved by that the known apparatus including: a charging unit which output serves for connecting to the accumulator battery being recovered; a current sensor; a voltage sensor; a temperature sensor; an electrolyte density meter; a memory unit; a processor, an interface unit; an indication unit; and a decoder; wherein the memory unit and the indication unit are connected to the processor, the current sensor, voltage sensor, temperature sensor, and electrolyte density meter are connected to the processor via the interface unit, the processor output is connected to the input of the decoder which first output is connected to the input for controlling connection of the charging unit and which second output is connected to the input for controlling parameters of the charging unit, in accordance with the present invention is provided with a discharging unit which input via the decoder is connected to the processor and which output is connected to the accumulator battery being recovered.

Other features and advantages of the present invention will become apparent from the following description of the invention which refers to the accompanying drawings.

### BRIEF DESCRIPTION OF THE DRAWINGS

The invention is illustrated by way of example and not limitation and the figures of the accompanying drawings in which like references denote like or corresponding parts, and in which:

FIG. 1 shows a schematic diagram of the apparatus for implementing the method for recovering the accumulator battery;

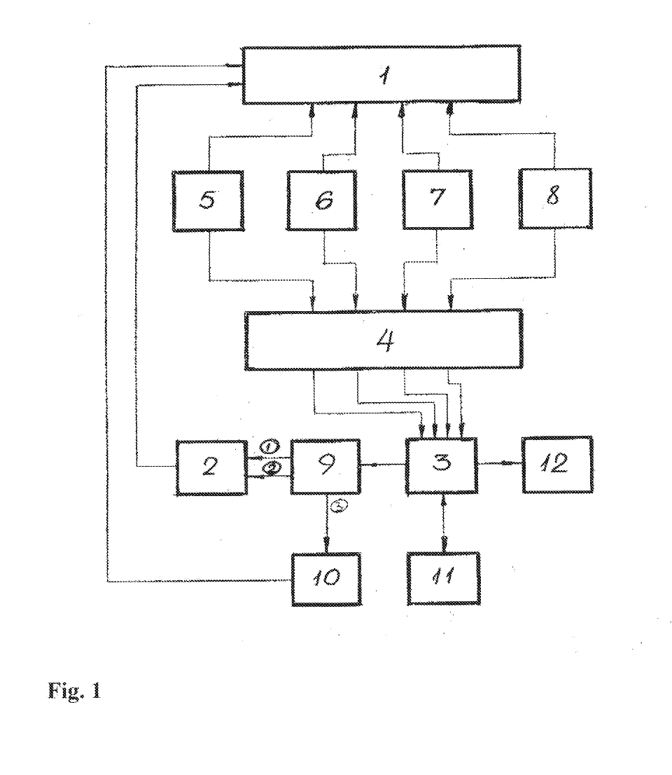

FIG. 2 shows time charts of the direct (1) and pulse (2) currents for charging-discharging the accumulator battery.

### DETAILED DESCRIPTION OF THE PREFERRED EMBODIMENT AND THE DRAWINGS

The apparatus for recovering the accumulator battery implementing the claimed method comprises: a charging unit 2 whose output serves for connecting to the accumulator battery 1 being recovered; a processor 3; an interface unit 4; a current sensor 5; a voltage sensor 6, a temperature sensor 7; and an electrolyte density meter 8. The current, voltage and temperature sensors 5, 6 and 7, respectively, as well as the electrolyte density meter 8 are connected through the interface unit 4 to the processor 3 whose output is connected to the input of the decoder 9. The first output of the decoder 9 is connected to the input for controlling connection of the charging unit 2, the second output is connected to the input for controlling parameters of the charging unit 2, and the third output of the decoder is connected to the control input of the discharging unit 10 which output is connected to the input of the accumulator battery 1 being recovered. The apparatus also comprises a memory unit 11 and an indication unit 12 both connected to the processor 3.

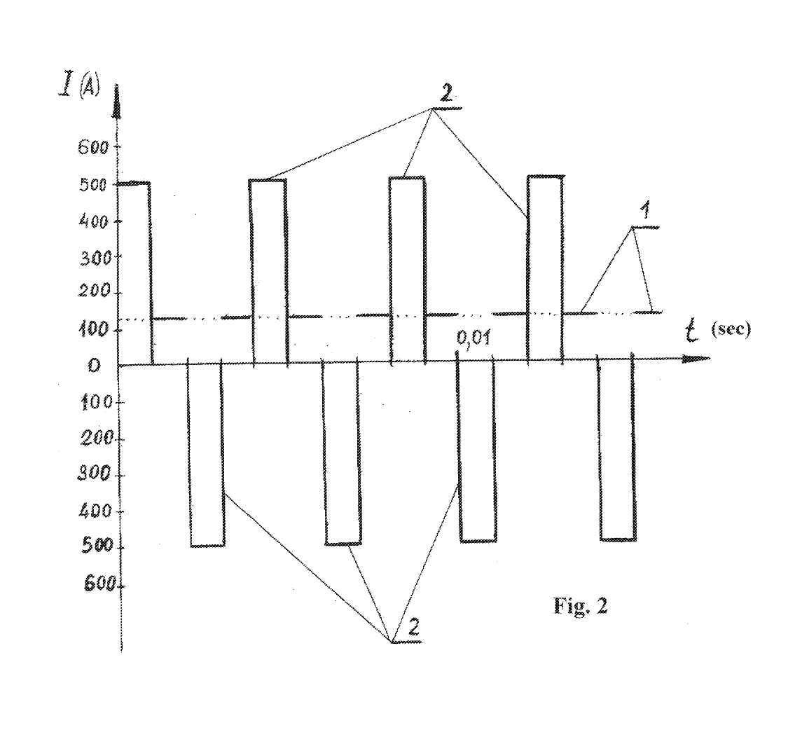

The method for recovering the accumulator battery, in accordance with the claimed invention, is implemented by the proposed apparatus as follows. Prior to the beginning of the process for recovering the accumulator battery, all necessary parameter values of the technological process for recovering the accumulator battery are input into the memory unit of the controller. A common processor can be utilized as the controller, and said processor controls said parameters during the entire technological cycle of the recovery. Monitoring of in-progress parameters of the technological process for recovering the accumulator battery, such as the charging and discharging current, voltage across the accumulator battery elements, electrolyte temperature and density, is performed by means of respective sensors for each of said parameters, the information on the in-progress values of such parameters is inputted into the processor. In accordance with the program, the incoming information is processed in the processor, the in-progress values of the parameters being monitored are compared with the preset parameters of the technological process of the recovery, and the signal for controlling the charging unit is formed based on the results of this comparison. In accordance with this signal, the accumulator battery being recovered is charged preliminary with the direct current. The time period of the preliminary charging is usually equal to several hours depending on the discharge degree of the accumulator battery being recovered. When the in-progress values of the parameters reach the preset values entered preliminary into the processor memory, which preset values are typically equal to one-third of the charge of the accumulator battery being recovered, the preliminary charging with the direct current is ceased. For example, in the case of acid accumulator battery, the preliminary charging thereof is ceased when the electrolyte density reaches the amount of 1.18 to 1.19 g/sm³ and voltage across the accumulator battery element reaches 1.85V. After that, the accumulator battery is charged and discharged with a sequence of the rectangular current pulses schematically shown in FIG. 2. The length and frequency of the pulses are determined by a type and conditions of the electrodes of the accumulator battery being recovered, and an amplitude of said current pulses is changed discretely during the charging after preset time periods up to the optimal value on the basis of the amount of the voltage measured across the elements of the accumulator battery being recovered. Thus, for the alkali accumulators, this preset voltage should be in the range of 1.1 V to 1.6V, and for the acid accumulators, it should be in the range of 2.0V to 2.6V. The process of charging the accumulator battery being recovered goes forward at the preset optimal amplitude of the charging and discharging current pulses. If the electrolyte temperature exceeds the amount preliminarily set and input into the processor memory, the charging current amount is decreased to the value at which the electrolyte temperature is in the preset range. When the monitored parameters reach, for example, a stable value of voltage across the accumulator battery elements or a stable value of the electrolyte density, which correspond to the values of said parameters preliminarily input into the processor memory and define the end of the process for charging the accumulator battery being recovered, the recovery process is ceased. Upon completion of the charging process, the capacity of the accumulator battery being recovered is measures by discharging thereof. The discharging process is ceased when voltage across the battery terminals reaches the maximum permissible value set for this battery; in so doing, the value of the current of the control discharge should correspond to the value of the similar parameter mentioned in the passport data on the accumulator battery being recovered. The recovery cycle is recommended to be repeated, if the capacity of the recovered battery is less than 90% from the nominal value.

As a result of the conducted investigations and obtained experimental results, the applicant believes that complex physico-chemical processes take place on the molecular level in the accumulator battery being recovered. As a result of acting on atoms with the pulse current “charge-discharge” having a value within the range of 400 to 480A for a thousandth fraction of a second, a resonance effect emerges in the cubic face-centered crystalline lattice followed by overthrowing one of outer electrons of the atomic core into the metal conduction band and returning thereof from the conduction band to the outer shell of the core, thus carrying out the transition of electrons from one lattice to another. The emerging resonance effect allows to clean the surface of the plates of acid accumulator batteries from lead sulfate at substantially 100%, and to disintegrate an electrode grain in alkali accumulator batteries. The indicated ranges of the current amount and duty ratio, wherein the claimed technical result appears, are obtained during simulation and confirmed by the experiments.

The apparatus for implementing the method for recovering the accumulator battery operates as follows. For recovery, the accumulator battery 1 is connected to the outputs of the charging unit 2 and discharging unit 10; the sensors for monitoring the main parameters of the process for recovering the accumulator battery, namely, the current sensor 5, the voltage sensor 6, the electrolyte temperature sensor 7 and the electrolyte density sensor 8 are connected through the interface unit 4 to the input of the processor 3 which detects a condition and monitors the parameters of the accumulator battery being recovered, which parameters are displayed by means of the indication unit 12.

Prior to the beginning of the process for recovering the accumulator battery, respective values of the monitored recovery parameters are input into the memory unit 11, taking into account the preliminary made diagnostic of the condition of an accumulator battery to be recovered. The start of the process for recovering the accumulator battery begins from forming and outputting a signal from the first output of the decoder 9 to the input for controlling the connection of the charging unit 2. According to this signal, a process for charging preliminary the accumulator battery being recovered begins and goes for the preset time period during which the processor 3 performs a step of comparing the in-progress values of the process with those preliminarily input into the memory unit 11. When the parameters being monitored reach the values equal to the amounts of these parameters preliminarily input into the memory unit 11, the processor 3 forms signals that come via the decoder 9 to the input for controlling the connection of the charging unit 2 and to the input for controlling the connection of the discharging unit 10, commutating them accordingly. Thereupon, the step of charging the accumulator battery begins, during which a sequence of the rectangular current pulses passes through the accumulator battery, the length of which pulses is defined by a type and condition of the accumulator battery being recovered and is set within the range of 150 to 600 ms. The step of discharging the accumulator battery is carried out in the pauses between the charging pulses, while holding the amplitude of the rectangular pulses unchanged. At the same time, the processor 3 monitors the in-progress values of the parameters of the process for charging the accumulator battery, when passing through the sequence of the rectangular current pulses, and compares them with the preset parameters preliminarily input into the memory unit 11. When the controlled parameters of the technological process for recovering the accumulator battery deviate from the predetermined values, processor 3 forms an appropriate signal which comes via the decoder 9 to the input for controlling the parameters of the charging unit 2 and carries out a correction of the output parameters thereof, until the controlled parameters of the technological process reach the preset amounts preliminarily input into the memory unit 11. When the values being monitored reach the parameter values defining the end of the process for charging the accumulator battery, which parameter values have been also input preliminarily into the memory unit 11, the processor 3 forms the signal releasing the charging unit 2 and discharging unit 10. The process for recovering the accumulator battery ends by measuring the capacity of the accumulator battery, for which purpose he accumulator battery is connected to a load providing for a preset amount of the discharging current. When voltage across the battery reaches the maximum permissible value for this battery, the battery discharge stops. If the measured battery capacity is less than 90% of its nominal value, the above described recovery cycle is repeated.

Thus, in accordance with the claimed invention group, proposed are the technical solutions ensuring to perform on commercially available standard equipment the technological process for recovering of a wide range of self-contained power sources, which solutions, in comparison with the known background, reduce twice or trice the time for recovering the self-contained power sources, increase the capacity of the accumulator battery being recovered substantially to the nominal value and reduces 3-5 times the electrical power consumption. The proposed hardware implementation of the method eliminates, as opposed to the closest analog, the necessity in additional equipment (discharging device having a weight of 50 kg), as well as the necessity for switching the accumulator battery from the charging device to the discharging device.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for recovering the accumulator battery including steps of:
charging preliminarily an accumulator battery with direct current;
during the charging process, measuring a voltage across the accumulator battery, and an electrolyte temperature and density;
logging measured parameters;
prior to beginning a process of recovering the accumulator battery, recording predetermined parameters of a technological process of recovering the accumulator battery into a memory;
during the process of recovering the accumulator battery, comparing the recorded predetermined parameters with values of the measured actual accumulator battery parameters, and correcting the actual parameters if the measured actual parameters deviate from the recorded predetermined parameters of the technological process;
terminating the step of charging the accumulator battery with the direct current when the measured actual accumulator battery parameters reach values of the predetermined parameters recorded in the memory;
thereafter, charging the accumulator battery by passing therethrough a sequence of rectangular current pulses while holding an amplitude of the pulses constant if a temperature of the electrolyte is below a predetermined temperature value, and, if the temperature of the electrolyte exceeds the predetermined temperature value, reducing the amplitude of the rectangular current pulses to a value at which the temperature of the electrolyte is decreased to the predetermined temperature value, the step of charging the accumulator battery being carried out by passing therethrough the sequence of the rectangular current pulses which have a magnitude in the range of 400A to 480A and a duty factor of 100 to 400;
discharging the accumulator battery during pauses between the rectangular pulses for charging;
terminating cycles of charging with the rectangular pulses and discharging during the pauses therebetween when the measured actual parameters reach values of the recorded predetermined parameters defining an end of the process for charging the battery;
thereafter, measuring a battery capacity by using a control discharge of the battery; and
terminating the control discharge when a battery voltage reaches a maximum permissible value set for the battery.

2. The method according to claim 1, further comprising a step of repeating the cycle for recovering the accumulator battery if the battery capacity is less than 90% of its nominal amount after the recovery process.

3. An apparatus for implementing a method according to claim 1, the apparatus comprising:
a charging unit an output of which is connected to the accumulator battery being recovered;
a current sensor:
a voltage sensor;
a temperature sensor;
an electrolyte density meter;
a memory unit;
a processor;
an interface unit;
an indication unit;
a decoder; and
a discharging unit,
wherein the memory unit and the indication unit are connected to the processor; wherein the current sensor, the voltage sensor, the temperature sensor and the electrolyte density meter are connected to the processor via the interface unit; wherein an output of the processor is connected to an input of the decoder; wherein a first output of the decoder is connected to an input for controlling connection of the charging unit, a second output of the decoder is connected to an input for controlling parameters of the charging unit; and wherein an input of the discharging unit is connected via the decoder to the processor and an output of the discharging unit is connected to the accumulator battery being recovered.
